(19) United States
(12) Patent Application Publication
(10) Pub. No.: US 2018/0082115 A1
(43) Pub. Date: Mar. 22, 2018

(54) METHODS OF DETECTING MOIRE ARTIFACTS

(71) Applicant: HP INDIGO B.V., Amstelveen (NL)

(72) Inventors: Liron Itan, Ness Ziona (IL); Oren Haik, Ness Ziona (IL)

(73) Assignee: HP INDIGO B.V., Amstelveen (IL)

(21) Appl. No.: 15/569,352

(22) PCT Filed: Jul. 17, 2015
(86) PCT No.: PCT/EP2015/066469

§ 371 Date: Oct. 25, 2017

(51) Int. Cl. G06K 9/00; G06K 9/62; G06K 9/46

(52) U.S. Cl. CPC G06K 9/00483; G06K 9/6259; G06K 9/4642; H04N 1/04; G06K 9/4652; G06K 9/00456; G06K 9/6282; G06K 9/4661

(57) ABSTRACT

A method of detecting Moire artefacts in a digital image comprises calculating at least one parameter relating to at least one feature of the digital image. The at least one parameter is compared to at least one corresponding threshold, wherein the at least one threshold is determined by a machine learning process, based on a set of example images and reference parameters for the set of example images. It is determined whether the digital image contains Moire artefacts based on the results of the comparing.

### BACKGROUND

Moire artefacts are false colour or texture artefacts that can appear in scanned, printed or photographic images. They often arise when an image with high spatial variation between pixels is sampled at a lower resolution than the final image and interpolation is used to reconstruct a higher resolution image. Moire artefacts can manifest as false colours or grey levels in an image or as false patterns such as “on-off” regions or watermark-like patterns, where no such patterns were present in the original image.

In quality control checks on a print target (for example a print media such as paper or a bed of build material in a three dimensional fabrication process), the printed media may be scanned or photographed to provide a scanned image of the printed image that can be compared to a reference digital image. Such scanning may introduce Moire artefacts into the scanned image if the resolution of the scanner is lower than the resolution of the printed media, and this can lead the quality control system to record print errors that are not present in the printed image.

### BRIEF DESCRIPTION OF DRAWINGS

Examples will now be described, by way of non-limiting example, with reference to the accompanying drawings, in which:

FIGS. 1a, 1b and 1c show three examples of Moire artefacts;

FIG. 2 is a flow chart of an example method for detecting Moire artefacts in a digital image;

FIG. 3 is a flow chart of an alternative example method for detecting Moire artefacts in a digital image;

FIG. 4 is a representation of a machine learning process, according to one example; and

FIG. 5 is a flowchart of an example method of determining the quality of a printed image.

### DETAILED DESCRIPTION

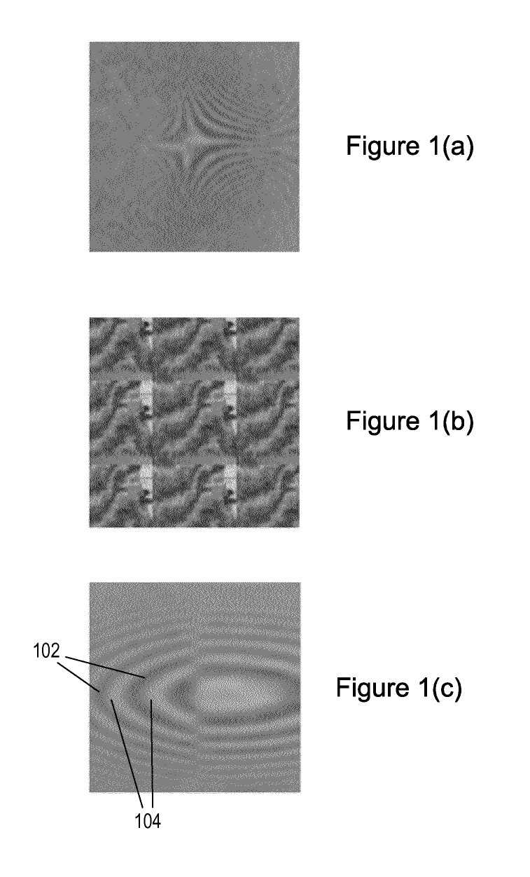

FIG. 1 shows examples of patterns characteristic of Moire artefacts, such as fringe effects in FIG. 1a, repeating patterns in FIG. 1b and watermark-like features in FIG. 1c. Moire artefacts also include colour artefacts such as repeating colours as indicated by reference numerals 102 and 104, which in this example indicate blue and red regions respectively.

To detect artefacts of this kind in digital images, some examples set out herein use a machine learning process, for example an iterative machine learning process, to generate a model or classifier that can be used to classify whether an image contains Moire artefacts or not. The machine learning process generates the classifier using a set of example images that contain examples of Moire artifacts and other ‘normal’ images that do not contain Moire artefacts. The classifier can be used to classify a new image that was not part of the set of example images.

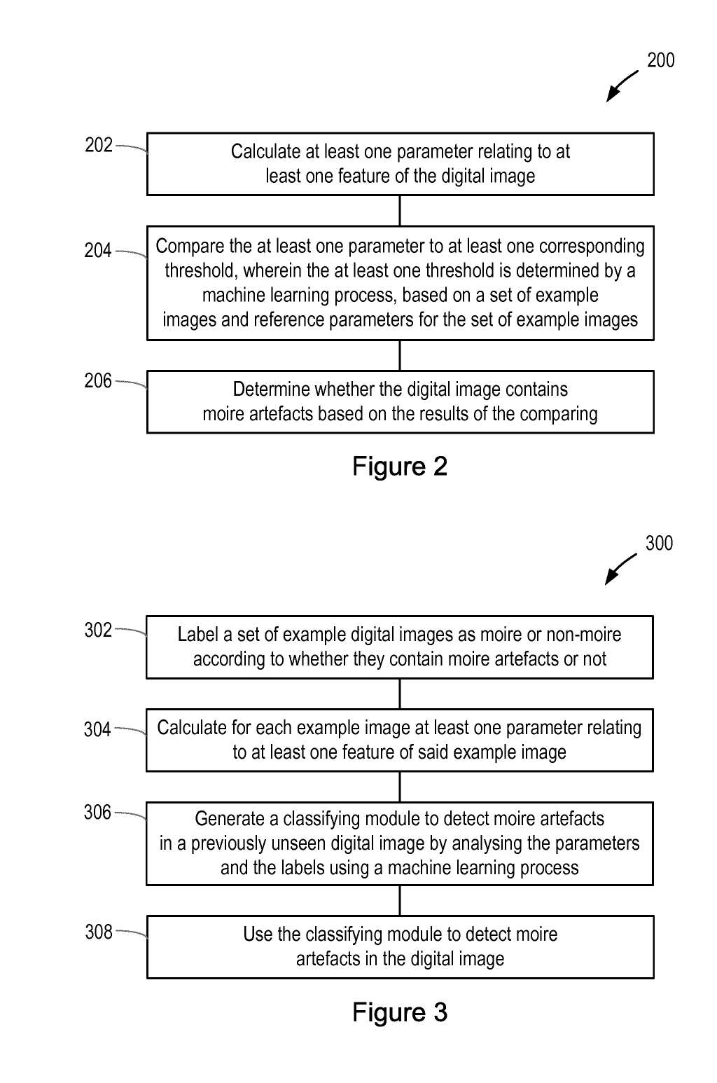

FIG. 2 shows an example method 200 of detecting Moire artefacts in a digital image. The method comprises calculating at least one parameter relating to at least one feature of the digital image, 202.

The method comprises comparing the at least one parameter to at least one corresponding threshold, wherein the at least one threshold is determined by a machine learning process, based on a set of example images and reference parameters for the set of example images, 204. The method further comprises determining whether the digital image contains Moire artefacts based on the results of the comparing, 206.

In one example, the at least one feature of the digital image is the luminance of a subset of pixels, and stage 202 may comprise calculating a parameter relating to the luminance. For example, the difference in luminance (i.e. gradient) between adjacent pairs of pixels across the image may be calculated, for example in both horizontal and vertical directions. It is noted that since a gradient is a 2D vector, it has both a magnitude (norm) and a direction. In some examples the gradient direction is used without the gradient magnitude, for example when using images in which the magnitude of differences between the pixel gray levels may be low. A histogram, referred to as a histogram of oriented gradients (HOG) of the luminance, can then be plotted. In some examples the parameter in stage 202 may be the width, the full-width-half-maximum (FWHM), the area under the HOG or the maximum value of the HOG. In alternative examples, the parameter may be the standard deviation or range of the luminosity gradients. In other examples, it may be a percentile of the range of luminosity gradients (e.g. the 50th, or 90th percentile) of the luminosity gradients.

According to an example as described above, the stage of comparing the at least one parameter to at least one corresponding threshold may comprise comparing the parameter to a minimum, maximum or range of values expected for Moire artefacts. For example, it has been observed that Moire artefacts are generally associated with narrow HOGs of the luminance (reflecting the ‘on-off’ type patterns depicted in FIG. 1), and therefore the threshold may stipulate the maximum value of the parameter that would lead to the image or image segment being classed as containing Moire artefacts.

In an alternative example, the at least one feature may relate to the colour contrast between pairs of pixels or groups of neighbouring pixels in the image. For example, a HOG of the colour channels may be plotted. In some examples, the parameter may be the width, the full-width-half-maximum (FWHM), the area under the HOG of colour channels or the maximum value of the HOG of colour channels. In alternative examples, the parameter may be the standard deviation or range of the colour channel gradient orientations (e.g. the standard deviation or range of the directions of the colour channel gradient vectors). In other examples, it may be a percentile of the range of colour gradient orientations (e.g. the 50th, or 90th percentile) of the gradients of the colour channels.

In alternative examples, the parameter may relate to both the luminosity gradients and colour gradients, for example, the parameter may be the width of the HOG of luminance compared to the width of the HOG of the colour channels.

In one example, a predetermined difference between the luminance HOG and colour HOG is used. For example, the predetermined difference may comprise determining a mean squared error (MSE) between the two histograms, i.e. between the luminance HOG and the colour HOG:

Sum((Hist1(i)−Hist̂2(i))2)/(num of histogram bins)

In another example, a technique known as histogram intersection may be used to determine the predetermined difference between the luminance HOG and colour HOG:

Sum(min(Hist1(i),Hist2(i)))

According to this metric, if the histograms are equal (and normalized), a result of “1” is obtained, whereas if the histograms are totally non-similar, a result of “0” is obtained. In one example, a predetermined difference is considered as existing between the two histograms if the value of this metric is smaller than a threshold value, for example smaller than “0.6”.

Sharp changes in colour in a repeating pattern are often associated with Moire artefacts, as illustrated in the examples in FIG. 1 (albeit being represented in greyscale in FIG. 1, rather than colour). In the example features relating to the colour contrast, the stage of comparing the at least one parameter to at least one corresponding threshold, may comprise comparing whether the colour contrast is above a minimum value expected for Moire patterns.

In another example, the feature may be the grey level. For example, the parameter may be the mean grey level and the threshold in stage 206 may be the maximum mean grey level expected for Moire patterns. Thus it may be determined in stage 206 that the digital image contains Moire artefacts if the mean grey level is below the threshold. Other parameters relating to the grey level may also be used, such as the range of grey levels, or the standard deviation of the distribution of grey levels.

It is noted that Moire artefacts can appear in certain areas of an image, whilst the remainder of the image is unaffected. Thus, the at least one parameter may be calculated across the whole image, or the image may be split into segments (for example 10×10 pixel squares) and the at least one parameter may be calculated separately for each segment to determine whether that particular segment contains Moire artefacts. The segments may be separated from one another or overlapping.

In some examples, the stage of calculating at least one parameter 202 may comprise calculating at least one parameter in a segment of the image (e.g. a box) centered on an area of the image where it is determined that there is a possible artefact. Therefore, in some examples, the method may further comprise comparing the digital image to a reference digital image and locating differences between the digital image and the reference digital image to determine areas of the image that may contain artefacts.

Stage 206, determining whether the digital image contains Moire artefacts, may comprise determining if each pixel is a Moire pixel and determining that the image, or segment of the image contains Moire artefacts if the number of pixels determined to be Moire pixels exceeds a threshold.

The machine learning process in 204 will now be described with respect to FIG. 3, which shows an alternative method of detecting Moire artefacts in a digital image 300. The method comprises labelling a set of example digital images as Moire or non-Moire according to whether they contain Moire artefacts or not, 302. The method comprises calculating, for each example image, at least one parameter relating to at least one feature of said example image, 304. The method comprises generating a classifying module to detect Moire artefacts in a previously unseen digital image by analysing the parameters and the labels using a machine learning process, 306, and using the classifying module to detect Moire artefacts in the digital image, 308.

A machine learning process, such as an iterative machine learning process, is a type of artificial intelligence that provides computers with the ability to ‘learn’ from past experience without being explicitly programmed. The ‘learning’ involves the ability to generalise from labelled examples in order to classify objects that have not been seen before. The set of example digital images in stage 302 act as a set of training data for the iterative machine learning process, and specify the correct output for a given example input. The set of example digital images are labelled as Moire or non-Moire according to whether they contain Moire artefacts or not. Each example is described by certain features, and a list of parameters are calculated for each image, relating to the features. Examples of features and corresponding parameters were given above with respect to the example in FIG. 2.

In one example the parameters and corresponding classification for each example image are provided to the machine learning process and the machine learning process uses the information about the example images to create a classifier that can be used to predict the label of a new (i.e. previously unseen) example. An example of a machine learning process that may be used is the Konstanz Information Miner (KNIME). Once the parameters have been calculated, the images themselves are no longer needed.

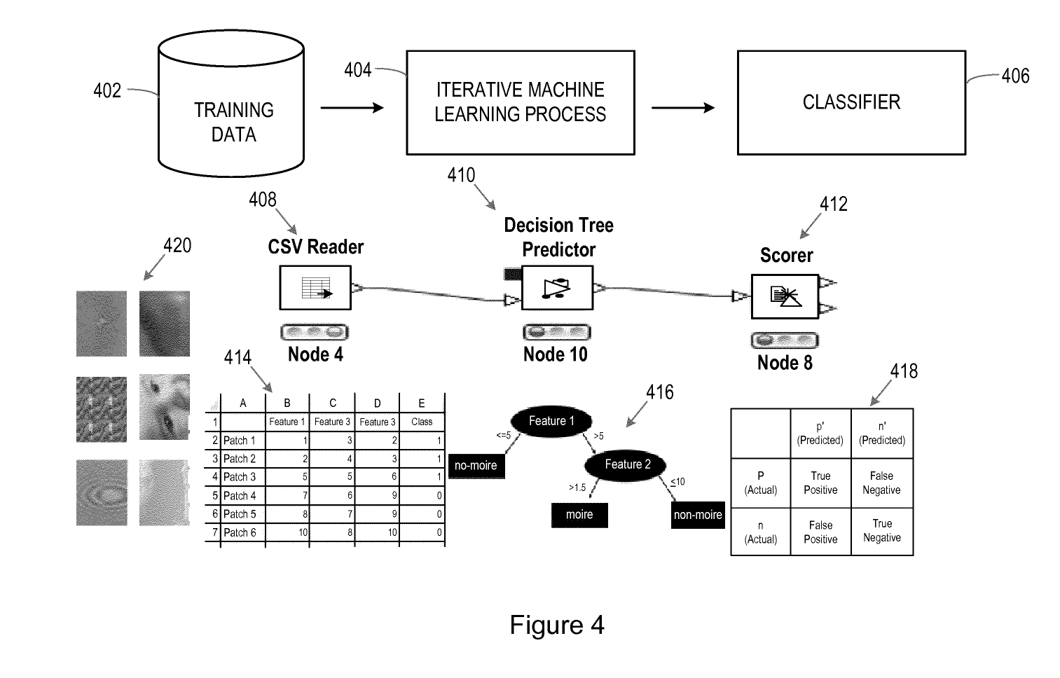

In some examples, the classifier generated by the machine learning process may be in the form of a decision tree comprising if-then rules. This is illustrated in FIG. 4 which shows a set of training data 402 gathered from a set of example images 420 that is input into a machine learning process 404 that generates a classifier 406. The classifier can be used to classify new images that were not part of the training data 404. In some examples, the training data may be in the form of a table, such as a table of comma separated variable (CSVs) 414 containing the values of the parameters for each feature and a binary class field indicating whether the image is Moire or non-Moire. The training data may be read into the machine learning process using a CSV Reader 408 and processed by a decision tree predictor 410 to produce a classifier 406. An example classifier in the form of a decision tree is illustrated at 416. The decision tree classifier may produce a result indicating whether an image or image segment is more likely to be Moire or non-Moire.

In one example, a scorer summarizes the classifier results by generating a table 418. In the example of FIG. 4 the table 418 contains four entries:
1. True Positive—number of true detections of Moire defects (meaning Moire defect that was indeed classified as Moire defect)
2. True negative—number of true detections of non- Moire defects (meaning non-Moire defect that was indeed classified as non-Moire defect)
3. False positive—False alarm rate, meaning number of non-Moire defects that were classified as Moire defects.
4. False negative—miss detect rate, meaning number of Moire defects that were classified as non-Moire defects.

Thus, according to another example, there is a classifier for determining if a digital image contains Moire artefacts, the classifier comprising at least one threshold relating to at least one feature of the digital image, wherein the at least one threshold was determined by a machine learning process, based on a set of example images and reference parameters for the set of example images.

In some examples, the classifier may have been generated according to the method described above. The classifier may be in the form of a decision tree 416 comprising at least one if-then type rule that can be used by a computer to determine if an image, or a part of an image contains Moire artifacts. The reference parameters used in the if-then rules in the decision tree relate to features in the image and example reference parameters that have been described above with reference to FIG. 2.

In another example, the classifier comprises a set of vectors that define the positions of a set of training images in a ‘feature space’ (e.g. parameter space). Each vector has an accompanying label which describes whether the corresponding image is Moire or non-Moire. A new image is classified as Moire or non-Moire, by calculating its vector in the parameter space and comparing the vector of the new image to the vectors of the training images to find the nearest neighbouring vector. The label of the new image is set as equal to the label of the training image that is the closest distance to it (distance in feature space). In another example, the classifier is based on a Support Vector Machine (SVM). This is a type of classifier finds a hyperplane (or line in the case of 2D feature space) that best separates Moire images from non-Moire images in parameter space. A new image will be classified as Moire or non-Moire depending on which side of the hyperplane (or line) it lies on.

In further examples, the classifier may be embedded in a computer program or control unit as part of a larger system.

According to one example, the classifier may be embedded in a quality control system for analysing the quality of a printed media produced in a print process. In such a quality control system, a printer stores a reference digital image in memory and prints the reference image onto the print media. In some examples, the printer may be a printer that prints printing fluid (e.g. ink) onto a print media such as paper. In other examples, the printer may be a printer for fabricating a three dimensional object. After the printer prints the reference image, the resulting image or three dimensional object is scanned or photographed and held in memory as a scanned digital image. The scanned digital image is compared to the reference image and any differences in colour or shape are flagged as potential artefacts.

As described above, the process of scanning itself may introduce artefacts including Moire artefacts into the scanned digital image and thus the scanned digital image may contain ‘real’ print artefacts introduced in the print stage and additional artefacts introduced in the scanning/photographing stage. In order to accurately assess the quality of the print process, artefacts introduced by the scanner (i.e. artefacts introduced in the quality control process itself) should be removed, since if they are not removed from the quality control process, they may be erroneously flagged as defects in the print process.

In order to remove false-positive Moire artefacts due to the scanning process, a classifier such as that described in the example above may be used.

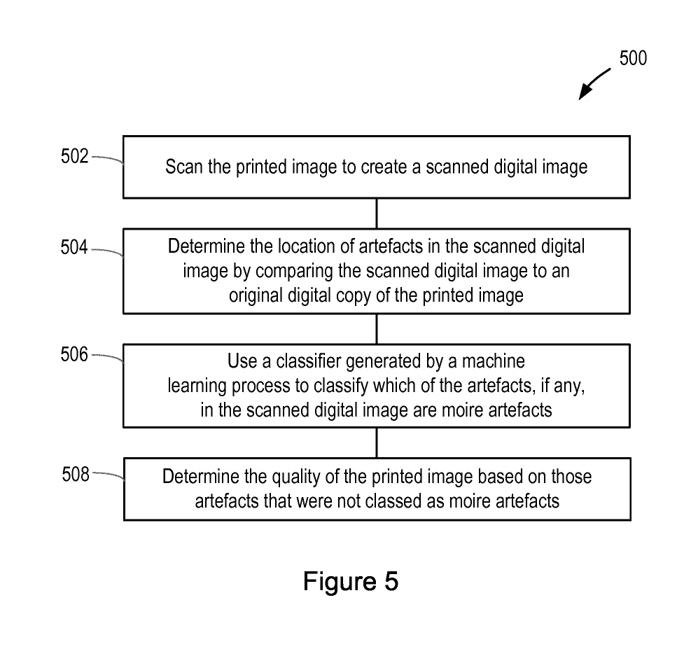

Thus, according to another example, as shown in FIG. 5, there is provided a method of determining the quality of a printed image. The method comprises scanning the printed image to create a scanned digital image, 502. The method comprises determining the location of artefacts in the scanned digital image by comparing the scanned digital image to an original digital copy of the printed image, 504. The method comprises using a classifier generated by a machine learning process to classify which of the artefacts, if any, in the scanned digital image are Moire artefacts. 506. The quality of the printed image is determined based on those artefacts that were not classed as Moire artefacts, 508.

In some examples, in 506, the classifier may consider a local region, for example a region within a bounding box (such as a 20×20 pixel box) around each artefact when classifying which of the artefacts, if any, are Moire artefacts.

In this way, the printed image can be more accurately compared to an original reference image, without taking into account false-positive Moire artefacts introduced when the printed image is scanned. Furthermore, the use of the machine learning process, for example an iterative machine learning process, ensures robustness of the resulting classifier, as the iterative machine learning process can produce a classifier based on features of a wide range of example images, for example 5000 images or more.

Furthermore, by including a mixture of real artefacts and Moire artefacts in the set of example images, the classifier can be trained to ensure that real artefacts in the printed image are let through, whilst Moire false alarms are removed.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited just by the scope of the following claims and their equivalents. It should be noted that the above-mentioned examples illustrate rather than limit what is described herein, and that many alternative implementations may be designed without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method of detecting Moire artefacts in a digital image, the method comprising:
calculating at least one parameter relating to at least one feature of the digital image;
comparing the at least one parameter to at least one corresponding threshold, wherein the at least one threshold is determined by a machine learning process, based on a set of example images and reference parameters for the set of example images; and
determining whether the digital image contains Moire artefacts based on the results of the comparing.

2. The method as in claim 1 wherein the at least one feature is a measure of the luminance contrast between two or more adjacent pixels in the digital image.

3. The method as in claim 1 wherein the at least one parameter is calculated using a histogram of luminance gradient orientations, HOG, between two or more adjacent pixels in the digital image.

4. The method as in claim 1 wherein the at least one feature is a measure of the colour contrast between two or more adjacent pixels in the digital image.

5. The method as in claim 1 wherein the at least one parameter is calculated using a histogram of luminance gradient orientations between adjacent pixels in the digital image and a histogram of colour channel gradient orientations between adjacent pixels in the digital image.

6. The method as in claim 1 wherein the feature is the mean grey level.

7. The method as in claim 1 wherein the at least one parameter is calculated in a subset of pixels of the digital image.

8. A method of determining the quality of a printed image, the method comprising:
scanning the printed image to create a scanned digital image;
determining the location of artefacts in the scanned digital image by comparing the scanned digital image to an original digital copy of the printed image;
using a classifier generated by a machine learning process to classify which of the artefacts, if any, in the scanned digital image are Moire artefacts; and
determining the quality of the printed image based on those artefacts that were not classed as Moire artefacts.

9. (canceled)

10. The method as in claim 9 wherein using the classifying module comprises calculating at least one parameter for the digital image; and
wherein the classifying module compares the at least one parameter of the digital image to the values of the at least one parameter calculated for the example images.

11. A classifier for determining if a digital image contains Moire artefacts, the classifier comprising:
at least one threshold relating to at least one feature of the digital image, wherein the at least one threshold was determined by a machine learning process, based on a set of example images and reference parameters for the set of example images.

12. The classifier as in claim 10 wherein the classifier comprises a decision tree.

13. The classifier as in claim 10 wherein the at least one threshold defines a hyperplane or line in a feature space that separates images with Moire artefacts from images with no Moire artefacts.

14. The classifier as in claim 10 wherein the at least one feature is a measure of the luminance contrast between two or more adjacent pixels in the digital image.

15. The classifier as in claim 10 wherein the at least one feature is a measure of the colour contrast between two or more adjacent pixels in the digital image.

16. The classifier as in claim 10 wherein the feature is the mean grey level.
